(19) United States
(12) Patent Application Publication
(10) Pub. No.: US 2008/0003147 A1
(43) Pub. Date: Jan. 3, 2008

(54) Fluid handling system for flow-through assay

(76) Inventors: William J. Miller, Horseheads, NY (US); Mark L. Morrell, Horseheads, NY (US); Todd M. Roswech, Ithaca, NY (US); Po Ki Yuen, Painted Post, NY (US)

Correspondence Address: CORNING INCORPORATED, SP-TI-3-1, CORNING, NY, 14831, US

(21) Appl. No.: 11/824,420

(22) Filed: Jun. 29, 2007

Related U.S. Application Data
(60) Provisional application No. 60/817,724, filed on Jun. 30, 2006.

(51) Int. Cl. B01L 3/02

(52) U.S. Cl. 422/100

(57) ABSTRACT

A fluid handling system for transferring fluids is disclosed. The fluid handling system incorporates a plurality of transfer units for dispensing and/or collecting fluids as part of a closed analytical system. The plurality of transfer units are capable of functioning independently and/or collectively when assembled in a unitary array format. Methods of making and using the fluid handling system are also disclosed. The fluid handling system allows a sub-array of transfer units to shift in a vertical direction independent from a position of another sub-array of transfer units that are assembled within the same fluid head. Therefore, the fluid handling system facilitates multi-port fluid delivery and collection in an array format. Further, the fluid handling system aligned with a sensing surface enables label-free detection assays to be performed in an analytical system.

### CROSS-REFERENCE TO RELATED APPLICATIONS

This application claims the benefit of U.S. Provisional Application Ser. No. 60/817,724 filed on Jun. 30, 2006 and entitled “Fluid Handling System for Flow-Through Assay” which is incorporated by reference herein in.

### FIELD OF THE INVENTION

The present invention relates generally to a fluid handling system for transferring fluids, and more specifically, to the method of dispensing and collecting fluids in a micro-channel device.

### BACKGROUND OF THE INVENTION

Instrumentation for label-free high throughput screening is commercially available and used as a drug discovery screening system. The system employs microplates, some of which utilize a sensing surface to detect biomolecular interactions by way of a change in refractive index at the sensing surface. With the integration of fluids and optical analytics with a substrate, the use of microplates has increasingly evolved. Characteristically, each open well of a multi-well plate has been capable of containing liquid or solid phase samples. Each well, however, must be filled by a pipetting system that drops the sample material into the open-well format. Since the main use of label-free detection in these open systems has been focused on kinetics (on and off-rate) analysis in addition to affinity analysis, there is a need to develop a closed system method to accurately establish kinetic conditions. There is a need for a device for use in studying the kinetics of biochemical interactions while dispensing fluids in a flow-through manner to an array of discrete flow channels in a microplate device.

One particular problem in integrating fluid flow across a microplate is the open system of the microplate, more specifically, the open array of wells. Typical multi-well plate assays rely on open systems with a fluid reservoir over the sensing surface to which fluid is filled or aspirated. The number of assays conducted on the plate is therefore limited. Additionally, the multi-well plates in industry today do not employ or control flow fields. The open system permits air and/or bubbles to contact the liquid in a well which disrupts any method or technique to enable flow. Any bubbles or air left in a well can obstruct fluid flow and lead to inconsistent and varied analytical results. Therefore it would be beneficial to monitor and regulate the flow of fluids through the dispensing system to ensure constant fluid flow without air bubbles. Further, constant fluid flow would enable various kinetics assays.

To ensure uninterrupted flow of fluid through a multi-channel device, there is a need for a fluid dispensing system that is capable of forming a closed system. While alignment of micron-sized features has proven especially difficult, it would also be beneficial if the fluid dispensing system was manufactured with delivery tubes that align with the ports of a multi-channel device while also micro-positioning the multi-channel device in the analytical system. When aligned, the delivery tubes would enable continuous flow of fluids into multiple ports and through each channel of the device. Furthermore, the closed system would be small enough to reduce gross expenditures in fluidic consumption during testing while also forming a tight enough seal to minimize any leakage.

Additionally, in order to integrate a sensing surface in the use of a flow-through device, typical flow cells as used in other areas of research and industry have utilized non-tangible interfaces of laminar flow to laterally shift liquid flow on or off the sensing area. This intricacy has been far too complex in the use of high-throughput devices such as multi-well plates as used in industry today. The technology confronts problems involving cross-talk or mixing between two or more fluids, and may further be complicated by any turbulence in the flow rates of fluid in the cells. Fluid dispensing systems as employed in current biotechnology have not been able to alleviate these frustrations, and therefore have not overcome the difficulties in obtaining consistent high-throughput kinetics analysis.

While sample delivery to the array of wells as presently employed in industry offers numerous advantages, improvements thereto are still desired. Accordingly, there is a need in the art for improved sample delivery techniques within the context of multi-well plate assays. Further needs would address the integration of a fluid delivery system with multi-well flow-through plates and/or multi-channel devices, including those used for label independent detection (LID) and other instrumentation of similar design or operation. To achieve a desirable analytical system for accurate kinetics measurements, the fluid dispensing system would be capable of forming and/or sealing the connection between a micro-channel device and the dispensing units of a fluid dispensing system to form a closed system. Such advancements will therefore benefit efforts to develop a method of using the fluid handling system to integrate fluid flow across a multi-channel plate. An improved method of dispensing fluids in a flow-through manner to an array of discrete ports and flow channels in a multi-channel format will further necessitate the development of a closed system with collection tubes to remove fluid from the channels and still maintain a constant flow rate across a sensing surface(s). Such improvements would eliminate contamination from external sources and enable high-throughput kinetics studies. Additionally, automation of the high-throughput fluid delivery system would facilitate screening of chemical or biological analytes for drug discovery. Further, multi-channel, multi-port fluid delivery is advantageous for rapid quantitative analysis of kinetic rates of association and dissociation across multiple sensing areas within the multi-channel device. The present invention fulfills these needs and provides further related advantages.

### SUMMARY OF THE INVENTION

A fluid handling system for flow-through assays is disclosed. The fluid handling system comprises an array of transfer units comprising one or more sub-arrays, each sub-array including a set of transfer units; and a first plate supporting a first set of transfer units and a second plate supporting a second set of transfer units, wherein the first plate is capable of moving the first set of transfer units independently from the second set of transfer units. The second plate is also capable of moving the second set of transfer units. A fluid pumping system in communication with a set of transfer units and a storage reservoir allows fluid to be directed in a directional flow through the transfer units. A means for connecting each transfer unit with the pumping system includes any type of connection including tubing, syringes, or storage tubes so that at least one transfer unit is a dispensing tip connected to the fluid pumping system and at least one transfer unit is a collecting tip connected to a collection reservoir or collection system. Furthermore, the transfer units may be of any material construction, metal tube, plastic flexible part with a passageway created therein, or may simply include a set of pins that are capable of transferring fluid.

One embodiment of the present invention includes dispensing tips synchronized in a first sub-array and a second sub-array for simultaneous or alternating interchange in a vertical direction. Therefore, it may be preferable to stabilize collecting tips in a fixed plate which can then provide a reference position for aligning all of the transfer units and tips.

An analytical system of the present invention comprises a plurality of dispensing tips in an array format, each dispensing tip having a conjugate collecting tip within the array format, a support network which delineates the array format, and one or more means for moving the dispensing tips or the collecting tips independently of one another. The means for moving may include any mechanical or electrical levers, screws or sensors that can position the transfer units within the array, and within the vertical orientations or lengths of the transfer units. Motorized devices may drive the lead screw or other means for precise positioning. Mechanical, electrical sensors or lasers can be utilized for positioning and movement of the transfer units as well.

The plurality of transfer units are disposed such that each transfer unit has one or more coordinated positions configured to align in the X-axis, Y-axis, and Z-axis directions, and the plurality of transfer units further provide a sealing interface for enclosing a micro-channel device. The sealing interface is advantageous for creating a rigid or semi-rigid closure to the micro-channel device while preventing damage to the fluid handling system or the micro-channel device during connection.

The fluid handling system further includes the one or more coordinated positions stabilized in X-axis and Y-axis directions wherein the dispensing tips are synchronized in a first arrangement/sub-array (first plate system) and a second arrangement/sub-array (second plate system) for simultaneous or alternating interchange in a vertical direction, and wherein the collecting tips are stabilized with a fixed plate. It is possible, however, that the collecting tips are arranged with a movable plate. One aspect of the invention includes a spring positioned between two plates of the first arrangement or second arrangement to adjust the transfer tubes and physically limit movement of the transfer units within the analytical interface assembly. The fixed plate is beneficial for providing a reference position for the dispensing tips and the collecting tips to align in a plane of the Z-axis. Furthermore, it serves to define the locations of the other transfer units.

The plurality of transfer units includes an array of dispensing tube pairs for fluid delivery so that each dispensing tube pair corresponds with one or more collecting tubes for fluid removal. The dispensing tubes and the collecting tubes are assembled in alternating rows in the planar X-axis and/or Y-axis directions. Therefore, when interfacing with channels of a micro-channel device, the fluid handling system provides at least two dispensing tubes with at least two flow fields connected via a channel of a micro-channel device to a collecting tube that continues the directional flow of fluid.

A method transferring fluids is also disclosed comprising the steps of: providing an array of transfer units such that the array comprises at least a first sub-array of transfer units and at least a second sub-array of transfer units; and shifting the first sub-array of transfer units in a vertical direction independent from a position of the second sub-array of transfer units. One method further comprises a step of withdrawing fluid from a storage source. Another method includes delivering fluid via the sub-array of dispensing tips in a first direction (e.g. downward) and withdrawing fluid in a second (e.g. upward) direction through a sub-array of collecting tips.

Other advantages of the present fluid dispensing system may be apparent by methods that include interfacing a fluid handling system with a micro-channel device having an array format comprising the steps of: providing a fluid handling system as stated above, withdrawing the fluid from one or more storage reservoir(s) into the dispensing tips, positioning the plurality of transfer units of the fluid handling system with the plurality of channels of a micro-channel device, and delivering a measure of fluid into the channels at a controlled rate, wherein the step of positioning includes providing a closed system so that the dispensing tips and the collecting tips seal the plurality of channels. The current rectangular footprint of one embodiment of the fluid handling system and a micro-channel device includes a multi-port sealing interface that access micron-sized flow chambers formed therebelow. The planar configuration of the micro-channel device enables the simultaneous and continuous delivery and removal of fluid from multiple channels. The fluid delivery system of the present invention is advantageous for screening of chemical and biological analytes, with or without an optical sensor included with the micro-channel device. Furthermore, the multi-port fluid delivery system facilitates expedient analysis of kinetics in drug discovery processes.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a perspective front side view of an embodiment of a fluid handling system.

FIG. 2 is a perspective side view of the plurality of transfer units in one embodiment in communication with a multi-channel device.

FIG. 3 is a partial perspective side view of an embodiment of the analytical system.

FIG. 4 is a magnified side view of a pair of transfer units interfacing with a multi-channel device in an embodiment of the present invention.

FIG. 5 is another magnified cross-sectional view of a single transfer unit in one embodiment of the closed system.

### DETAILED DESCRIPTION

In the following detailed description, for purposes of explanation and not limitation, exemplary embodiments disclosing specific details are set forth in order to provide a thorough understanding of the present invention. It will be apparent, however, to one having ordinary skill in the art that the present invention may be practiced in other embodiments that depart from the specific details disclosed herein. In other instances, detailed descriptions of well-known devices and methods may be omitted so as not to obscure the description of the present invention.

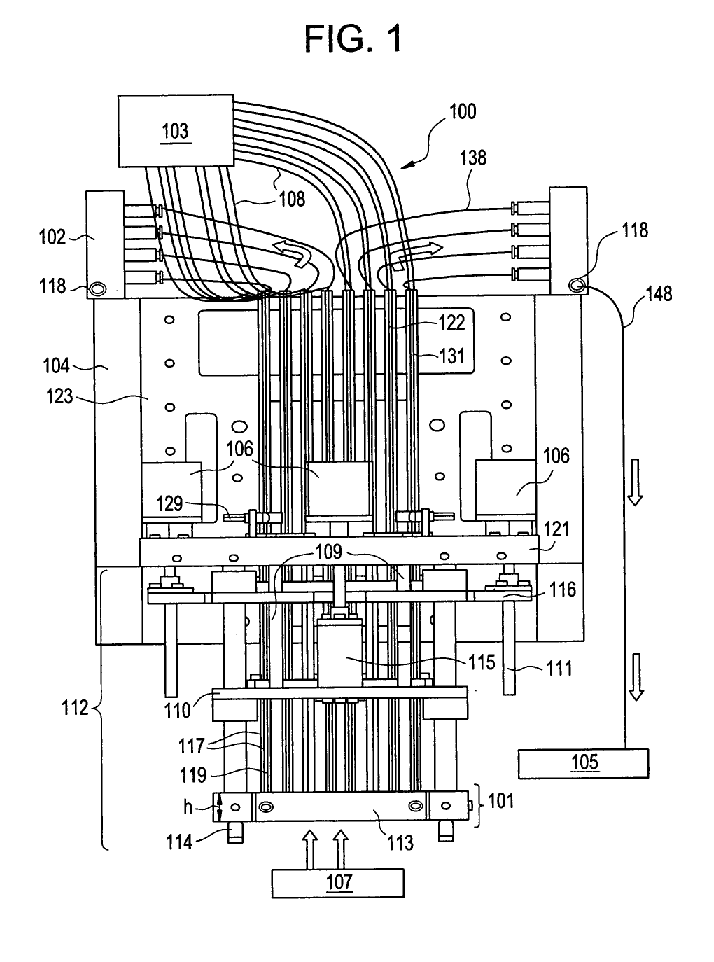

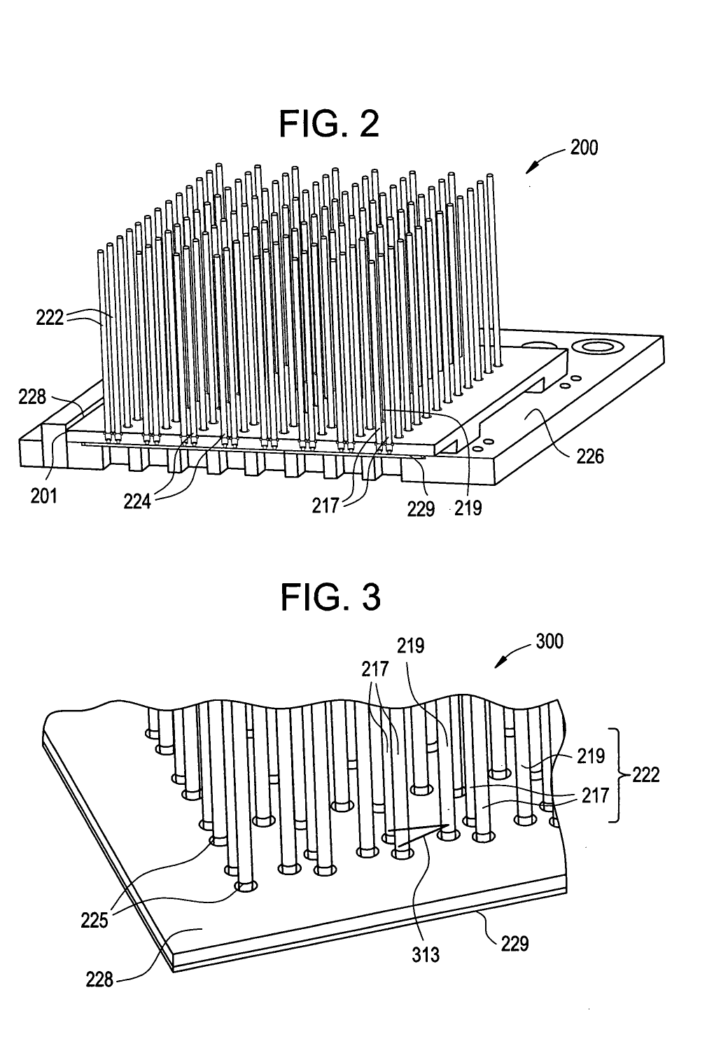

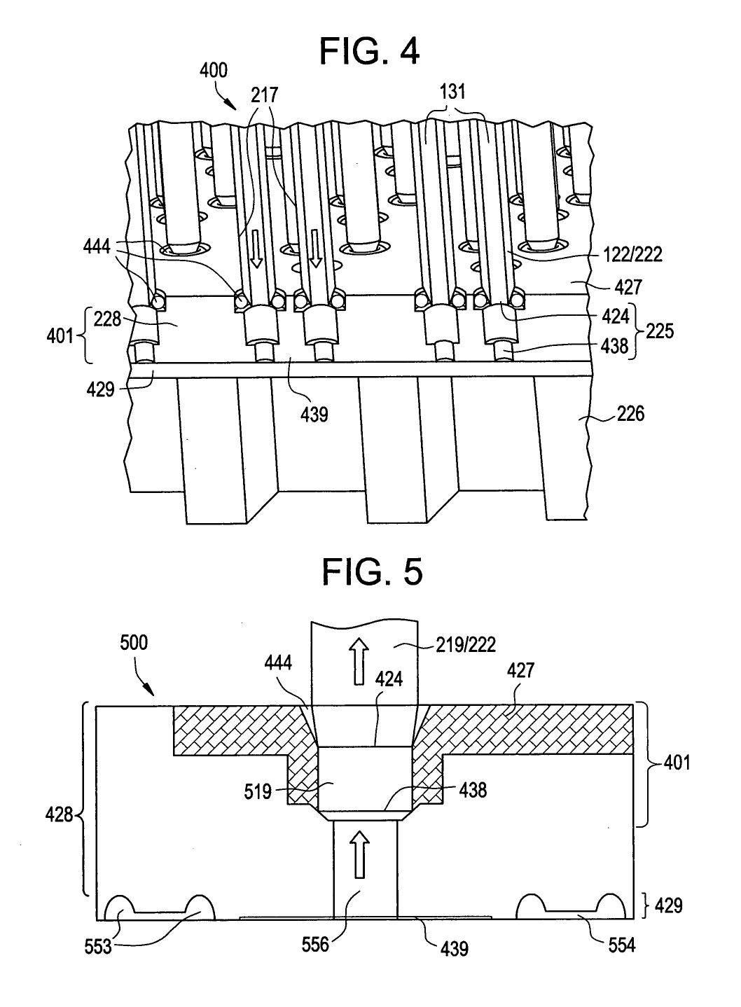

In accordance with one embodiment of the present invention, an external view of a fluid handling system 100 is shown in FIG. 1. The fluid handling system 100 includes a fluid head 112 that includes multiple transfer units 122 positioned in a rectangular array format. The array as illustrated in FIG. 2 includes the transfer units 122 in a unitary array such as a fluid head 112. As illustrated, the fluid head is positioned on a mounting frame 104 and is capable of moving in X-axis, Y-axis, and Z-axis directions, perpendicular to one another. The plurality of transfer units 122 therefore are disposed and coordinated in positions configured to align in X-axis, Y-axis, and Z-axis directions with multiple channels of a micro-channel device. Flexible tubing connections 108 serve as means for connecting individual transfer units 122 with a fluid pumping system 103 or with a collection reservoir 105. The connection 108 allocates each transfer unit as a dispensing tip 117 or collecting tip 119, respectively. The fluid pumping system 103 permits fluid delivery at a controlled rate through a pathway or flow field 131 (See FIG. 4) in the fluid handling system 100. In one aspect, the flow field 131 is within each individual transfer unit, the directionality dependent on the pumping direction of fluid through the system. Depending on commands to motor counts or revolutions of a motorized pump 103, a controlled volume of fluid can be delivered through the plurality of transfer units 122 per one measure (e.g. a time interval or rate period). For simplicity of referencing a test flow and a sample flow, two transfer units 122 are utilized as dispensing units/tubes 117 and are directly connected to the fluid pumping system 103 to establish two directional flow fields 131 into each channel of a multi-channel device. In this embodiment, a single collecting unit/tube 119 removes fluid from each channel. More than one collecting tube 119, however, may be utilized.

The dispensing tips 117 and collecting tips 119 are stabilized in the array format by a guide plate 113. The guide plate 113 is internally hollowed out as a support network 113 for each transfer unit/tube 122 so that the height (h) of the guide plate 113 covers a micro-channel device or well-plate assembly. The guide plate 113 therefore assists in eliminating any stray light that may interfere with optical analyses of a micro-channel device or well-plate. Furthermore, alignment pins 114 on an underside of the guide plate 113 are diagonally positioned on opposite corners to align with guide bushings of a micro-channel device or well-plate. When the guide plate 113 aligns the transfer tubes 122 with each channel of a micro-channel device, each dispensing tip 117 and each collecting tip 119 in combination provide a sealing interface 101 for enclosing a micro-channel device to form a closed analytical system.

In one aspect (FIG. 2), the sealing interface 201 includes tapered tips 225 of the transfer units 222 that seal with inlet and outlet ports 224 of a micro-channel device 228. The micro-channel device 228 in one embodiment contains multiple micron-sized flow chambers/channels between a bottom wall of a substrate and an upper surface of a cover or sealing interface 201. A lid (ie. Robolid™, manufactured by Corning Incorporated), cover, or sealing interface may include discrete inlet and outlet ports, one of each, two of each, or an assorted combination of two inlets, one outlet, or vice versa so that simultaneous flow can be assayed within each chamber or channel. The lid may be a separate cover such as for use with standard micro-well plates, or may be an integrated sealing interface that serves as a closure to the closed system. Preferably, the sealing interface 201 is leak-proof yet flexible enough to correct any alignment deficiencies so that fluid may flow across an analytical surface 229. In addition, the micro-channel device 228 is inserted onto a stage 226 to secure the device 228 and prevent any undesired movement of the device as the fluid tips 225 insert into the aligned respective ports 224.

Referring back to FIG. 1, a connection 108 between each dispensing unit 117 and the fluid pumping system 103 facilitates transfer of fluids into the flow field 131. Another connection 138 between each collection tip and an exhaust manifold 102 is utilized to remove fluid from the system. In one aspect, the exhaust manifold 102 utilizes gravity to drain the fluid into a collection reservoir 105 via a drain tube 148. In another aspect, however, a vacuum may be utilized to remove fluid from the system. For exemplary purposes only and not further limitation, several means for connecting 108/138/148 each transfer unit with the fluid handling system 100, may include flexible or rigid tubing, syringes, and/or storage tubes or reservoirs.

In one embodiment (FIGS. 2 & 3), the fluid handling system has 288 transfer units: 96 pairs of dispensing tips 217 adjacent to one another and 96 individual collecting tips 219, each individual collecting tip 219 forming a triad 313 with each pair of dispensing tips 217. In a standard 96-well plate, the center-to-center spacing between each well is about 9 mm. In a 384-well plate, the center-to-center spacing between each well is about 4.5 mm. Any spacing, however, may be utilized in combination with the fluid handling system with adjustments to accommodate a well plate of various dimensions, or having any number of wells. A closer look at the transfer tips 122/222 as shown in FIG. 4 depicts each dispensing tip 217 delivering fluid into a channel 439 of a multi-channel device 228 to provide a dual flow of fluid through the micro-channel device across the surface 429 to a collecting tube 219 which removes the fluid by way of the tapered collecting tip 424. The portion 438 of the tapered collecting tip 424 securely engages with the sealing interface 401 to enclose the analytical system 400. Seals 444 around each transfer unit 222 of the fluid handling system contribute to the sealing interface and can be constructed of any known seal in the art including O-ring seals, silicones, delivery tubing or elastomeric-type materials. Consequently, the entire sealing interface may be a continuous sheet 427 adherent to the fluid head and may be constructed of a material such as silicone for flexible assembly to the fluid handling system for a liquid tight seal as well as for ease of removal to prevent cross contamination. When positioned with a micro-channel device, the seals and/or continuous sealing sheet of the fluid handling system will assist in positioning and aligning the transfer units with each channel. Therefore, numerous fluids may be dispensed through the fluid handling system in a continuous flow-through assay and without escaping the sealing interface.

A magnified cross-section of the sealing interface 401 is illustrated in FIG. 5 including the collection tube 219 sealed with a micro-channel device 429 to form the closed analytical system 500. The flow field 556 of the fluid handling system is in fluid communication with an analytical channel 439. Since the collection tip 519 is removing fluid from the channel 439 in this embodiment, the two dispensing units are positioned on the opposite side of the channel 439 (dispensing units 217 are shown in FIG. 4). Further, seals 444 integrally formed within an elastomeric interface 427 ensure that fluid does not leak out of the closed system. Additional features of the closed system may include adhering sites 554 for securing plate 428 to plate 429. Any extraneous adhesive that seeps out of the space 554 will be captured by run-off areas 553 so as to not interfere with the channel 439. Other additional features to seal various potential sites for fluid leakage in the closed system are without further limitation.

Additionally, in any embodiment, the coordinated positions of the multiple transfer units 122/222 are configured to aligned in X-axis, Y-axis, and Z-axis directions in the array format. The mounting frame 104 in one embodiment is the main frame body comprising brackets 123 to secure individual motorized stages/plates 110/116/121. Although individual motors 106 can be used to control each directional movement of a plate, the embodiment illustrated includes 2 motors A and 2 motors B that control movements of plates [sub-arrays] corresponding to individual groups or pairs A and B of dispensing units 217, respectively. In one embodiment, two motors 106 access a first motorized yoke plate A (110) and two additional motors 106 control a second motorized yoke plate B (116), each yoke/support plate of which is operated independently of one another so that specified transfer tubes 122 associated with each independent yoke plate are capable of moving in respective modes. The independent support plates, yoke plates A and B, support the sub-arrays of transfer units In one aspect, the modes include dispensing tips synchronized in a first arrangement/sub-array (110) and a second arrangement/sub-array (116) for simultaneous or alternating interchange in Z-axis direction while collecting tips are stabilized within a fixed plate 121. The independent movement of the individual sets of transfer units/tubes 122 associated with each yoke plate A and B prevents contamination of fluids with solutions stored within source plates as well as between transfer units. Lead screws 111 in conjunction with the motors 106 mobilize plate B (116) in Z-axis direction. Multiple dispensing tubes 117 are positioned with yoke plates A (110) and B (116) to alternately access a source plate 107 at each end or tip. Plate A (110) has been demonstrated with 96 tubes/units connected to motorized plate A and another 96 units positioned with motorized plate B (116). Exhaust or collecting units 119 are clamped to a fixed exhaust tube plate 121 which provides a referencing position 121 for all of the transfer units 122. Motors A and B are mounted to the exhaust plate 121 in addition to limit switches 129 that utilize the reference/home location 121 by way of an optical or mechanical sensor. Extended pins trigger the optical sensor to set and align the transfer units 122, dispensing tips 117 and collecting tips 119, to the home location 121 in the Z plane. Since the tubes in this embodiment are symmetric, approximately 12 inches in length, a home location 121 ensures that the tubes 122 are all at the same height with tips aligned at the same Z-axis position.

Also illustrated in an embodiment of the present invention is an extension (or longer lead screw) 115 to allow the A tube motorized plate 110 to extend even farther in the downward Z-axis direction. In one aspect, the extension 115 is a lead screw nut that can be incorporated with any of the motorized plates. In addition, the fixed plate 121 containing the exhaust or collecting tubes 119 is capable of being motorized. Therefore, all tips would extend to an interface 101 with a source plate 107, micro-channel device 228, alternative collecting reservoir, or other surface(s). Moreover, the dispensing tips 117 and the collecting tips 119 may function collectively and/or independently for interfacing with the storage reservoir(s) 107 or various surfaces that provide an interface to multiple variations of a micro-channel device. The fluid head 112 may also have dispensing tubes 117 and/or collecting tubes 119 capable of including end tips 519 with compression and/or expansion components 519 (FIG. 5), each individually or cooperatively controlled. Such components may include spring systems to allow the transfer units to interface smoothly with a micro-channel device 429. The compression and/or expansion components 519 may be integrated with each dispensing tip or collecting tip 424.

In use, the fluid handling system is capable of interfacing with a multi-channel device in an array format for high-throughput screening. The fluid handling system as described is provided such that the plurality of transfer units includes pairs of dispensing tips corresponding with individual collecting tips. As initially positioned, the fluid head allows the dispensing units to extend into a source plate(s) that may include multiple storage reservoirs. Fluid is withdrawn from the storage reservoir(s) of the source plates into each dispensing unit. The plurality of transfer units are then positioned and aligned in X, Y, and Z-planar axes with the array of channels in a micro-channel device; each channel interfaces with two dispensing tips and one collecting tip. The dispensing tips align with inlet ports and collecting tips align with outlet ports to -access an input side of a multi-channel device so that several assays can be performed in a flow-through manner to obtain benefit from the closed multi-channel system. A measure of fluid is then delivered into the channels at a controlled rate by a fluid pumping system. The closed system including the fluid handling system and the micro-channel device is leak proof in a tight sealing of the dispensing tips and the collecting tips with the channels. Various rates of flow may be integrated within each channel depending on the fluid pumping system. Continuous flow of fluid from dispensing tubes into the dual inlet ports of the micro-channel device, across the channel, and through the individual outlet ports into collecting tubes facilitates rapid quantitative kinetics analysis of biochemical assays. Furthermore, maintaining equivalent rates of flow between each flow field or pathway ensures the accuracy of the analysis.

A pumping system 103 may consist or one or more pumps. In one embodiment in which two dispensing units are utilized, two pumps are incorporated within the system. The system itself includes a self-cleaning mechanism that allows water, a buffer solution, or sample solution to pull from behind the pumping system instead of directly from source plates. However, backing fluid is normally used to wash out any residuals that may remain in the tubes, and is additionally used to reduce compressibility problems that may occur. For instance, in one embodiment, a valving system (e.g. a 3-way valve, including a control check valve) eliminates any residual/trapped air in the transfer lines or tubes and allows fluid to be withdrawn into the tubes from source plates. A bubble between the backing fluid and another solution, for example, is small enough (as minimized by the sizing of the tubes and surface tension created within the tubes) to provide spacing between the two distinct fluids within the tube. Otherwise, friction on the inner walls of the tubes holds one fluid to the walls while another fluid is drawn up through the center, causing additional problems with contamination of fluids. Furthermore, the size of the tubing itself creates enough surface tension to define a region between two fluidic solutions within the same tube which prevents any interference of the residual air/bubble from drawing to the topmost portion of the tube and interfering with flow rates. Therefore, by priming the system with the use of backing fluid, any residual air in the system is eliminated and various solutions may be contained and segmented within the same tube at the same time. Multiple variations of the pumping system may be configured to utilize the procedure described or alternate the direction of fluid flow within the tubes.

In the analytical system 300 of one embodiment, the dual dispensing tips 225 with dispensing tubes 217 are positioned vertically and synchronized so that dispensing units 217 of plate A and dispensing units 217 of plate B are operated simultaneously when withdrawing fluid from a source plate and when dispensing fluid into a multi-channel device. The dispensing units 217 or tips 225 of plate A and plate B, however, may be operated in alternating interchange so that only the tips of plate A extend into a source plate or only the tips of plate B. Therefore multiple source plates could be utilized to withdraw a variety of different fluids. Then, when interfacing with a planar surface of a multi-channel device, the fluid dispensing tips A and/or B may initiate an individual flow of fluid through a channel or a dual flow of different fluids. In one embodiment, all of the transfer units/tubes 222 protrude through their respective plates and are further secured at the tips 225 by way of the guide plate 113. As previously described, the guide plate is substantially hollowed out to provide just enough security in positioning the tubes. However, the guide plate 113 is also capable of covering a multi-channel plate assembly 228 to substantially eliminate any stray light from interfering with the closed analytical system.

Alternatively, fluid storage reservoirs may not be individual source plates distinct from the fluid handling system. Instead, the fluid storage reservoirs may be integrated with the fluid handling system so that the flow pathway of the dispensing units is uni-directional for filling the dispensing units and initiating a flow field for testing. Therefore, fluid would flow in through one end of the tube and out through the tips continuously. Evidently, however, due to system capacitance, the delivery of fluid is not as instantaneous as when utilizing the source plates to withdraw fluid into the tubes. Withdrawing fluid prevents air from contaminating the fluid handling transfer units.

In another aspect, each transfer unit 222 may be connected to a fluid pumping system. One fluid pumping system would allocate fluid in a directional flow pathway into the micro-channel device while another second fluid pumping system or vacuum system would remove fluid through the collecting tips out through the flow pathway of the collecting tubes to the exhaust manifold and collecting reservoir.

Supplementary, integrating the use of label-independent detection (LID) with the fluid handling system proves advantageous for identifying various compounds and substances in gaseous, liquid, or solid phase samples. By utilizing a fluid handling system of the present invention, continuous fluid flow across an array of sensing surfaces facilitates chemical, biochemical and cell-based binding interactions in a true kinetic format, including accurate affinity studies. Flow of two fluids across the same sensor is an efficient way of performing these analytical measurements such that vibration, turbulence in fluid flow, temperature, and pressure factors are null in analysis. Therefore, the fluid handling system provides a novel interactive interface to enable the use of LID plates and systems as currently used in biotechnology. Continuous flow permits diversified kinetics measurements and further addresses mixing and/or efficient fluid replacement in a high-throughput format. Moreover, simultaneous control of fluid into and out of the individual fluid transfer units enables controllable measures to prevent contamination between transfer units and further ensures control in a closed analytical system.

As demonstrated above, the fluid handling system of the present invention provides a three dimensional format for interconnecting with a three dimensional micro-channel device. It is likely, however, that the fluid head may demonstrate greater benefit if mobilized within a mounting system. Even mobilizing the mounting frame itself may permit greater ranges of motion and allow the transfer units to interface with a wider variety of analytical surfaces, devices, and/or instruments in any 3-dimensional direction.

The fluid handling system may be made by any number of acceptable manufacturing methods well known to those of skill in the art. In one aspect, the transfer units are steel tubes mounted in a rigid structural system of metal parts. However, various materials as utilized in biological and chemical applications such as polymeric or glass materials may be beneficial for providing connections between parts of the system or for replacing the currently used steel transfer unit assembly. If utilizing plastic or glass materials to contain fluid, such materials must be rigid enough maintain a structure to support storage of the fluids for analytical testing, yet pliable for interfacing with a micro-device. When rigid materials such as metal or steel are utilized, spring-loaded systems provide the flexibility of the fluid head to engage with the micro-channel device without damaging analytical surfaces. Furthermore, the transfer tubes and tips may be of any desired configuration to accommodate minimal to maximum volume potentials. Therefore, tube diameters of any size may be incorporated, even if this includes forming two pathways within one transfer unit. Thus, two or more flows of fluid could be incorporated within a transfer unit and may facilitate fluid flow into a modified micro-channel device that does not necessarily have distinct and separate inlet ports as utilized currently. Flow-through passage-ways, however, may not be required if tips are capable of transferring fluids at their ends.

Though continuous liquid flow-through assays are attributable to the fluid handling system of the present invention, it is eminent that various multiple fluids may be incorporated in the fluid handling system. If the sample is liquid, the fluid should have a viscosity to adequately flow through the diameters of the flow pathways in each transfer unit. The viscosity should not interrupt the continuous flow of fluid through the transfer units and connection tubing or through the channels of the micro-channel device. Additionally, viscous fluid should be free from air or bubbles. Without limitation, however, the fluid handling system may also provide a gaseous fluid flow. Thus, as represented, the analytical system is advantageous for its use in continuous liquid or gaseous flow-through assays.

As exemplified, various embodiments of the present invention offer several improvements over the open dispensing systems currently utilized with standard open-well microplates in industry. The improved fluid handling system enhances the delivery of fluid samples to a micro-channel device/plate for high throughput analysis. Accordingly, the fluid handling system accommodates multiple fluids and sample solutions to generate flow fields within each transfer unit into and/or out of a micro-channel device. The planar configuration of a micro-channel device is complementary to interfacing with the fluid handling system. As utilized with a sensing surface for label independent detection (LID) applications and other instrumentation of similar design or operation, the fluid handling system drastically improves the quantity and accuracy of flow-through assays that can be simultaneously performed in the micro-device. This improvement in fluid delivery in an array format facilitates high-throughput measurements within a closed system and even provides the sealing interface that forms the closed system. The micro-dimensions intricately space each transfer unit to align with an array of channels specific to a particular micro-device. Therefore, the fluid handling system may accommodate various embodiments of a micro-device, including multi-well plates, micro-channel or multi-chamber devices. Since the cross-sectional dimensions of a channel or well define where the dispensing units and collecting units should be positioned to create a flow field, a fluid handling system may incorporate any number of dispensing tubes and/or collecting tubes so long as the tubes are capable of engaging with the micro-device and sealing the interface. Consequently, the flow-through pathways impact the measuring of various kinetic rates such as rates of association and dissociation (kₒₙ and k_{off} rates). These measurements now have greater precision in the sealed analytical system.

Embodiments of the present invention are intended for exemplary purposes only and not limitation. Other embodiments of a device of the present invention may incorporate additional transfer units for dispensing and/or collecting fluids in a flow pathway. For exemplary purposes only and not further limitation, standardized dimensions or features of the fluid handling system to employ robotic manipulation would be beneficial to permit utilization of current instrumentation and methods as used in microplate technology. Therefore, larger or smaller three-dimensional array formats of the transfer units may be utilized to accommodate any number of channels or wells in multiple array formats. In addition, embodiments of the invention may be modified to take the size and shape to accommodate any multi-channel device used in industry. For example, any polygonal or circular shaped array format of the transfer units in the fluid handling system may be constructed to provide a sealed interface with a flow-plate or device of similar design. Other biological applications may further include additional transfer units to provide nutrient media or ventilation release mechanisms with cellular growth and microbiological chambers. The invention being thus described, it would be obvious that the same may be varied in multiple ways by one of skill in the art having had the benefit of the present disclosure. Such variations are not regarded as a departure from the spirit and scope of the invention, and such modifications as would be obvious to one skilled in the art are intended to be included within the scope of the following claims and their legal equivalents.

We claim:

1. A fluid handling system for flow-through assays comprising:
an array of transfer units comprising one or more sub-arrays, each said sub-array including set of transfer units;
a first plate supporting a first set of transfer units and a second plate supporting a second set of transfer units, wherein said first plate is capable of moving said first set of transfer units independently from said second set of transfer units.

2. A fluid handling system according to claim 1, wherein said second plate is capable of moving said second set of transfer units.

3. A fluid handling system according to claim 1, wherein said first plate and said second plate have supports configured to align each said first and second sets of transfer units in at least one planar direction.

4. A fluid handling system according to claim 1, further comprising one or more fluid pumping systems capable of connecting to at least one set of transfer units for directing flow into or out of said transfer units.

5. The fluid handling system according to claim 4, wherein one or more fluid pumping systems are in communication with one or more storage reservoirs and said array of transfer units, said storage reservoirs capable of supplying or removing fluids in a closed analytical system.

6. The fluid handling system according to claim 1, wherein said first set of transfer units are dispensing tips and said second set of transfer units are collecting tips.

7. The fluid handling system according to claim 6, wherein said dispensing tips are synchronized in a first sub-array and a second sub-array for simultaneous or alternating interchange, and wherein said collecting tips are stabilized.

8. The fluid handling system of claim 7, wherein said dispensing tips are arranged in pairs for fluid delivery, each said pair corresponding with one or more collecting tips for fluid removal, said dispensing tips and said collecting tips assembled in alternating rows in said array.

9. The fluid handling system according to claim 1, further comprising at least one seal included with each said dispensing tip and each said collecting tip, said seal(s) defining a sealing interface for enclosing a micro-channel device.

10. The fluid handling system of claim 1, further comprising compression and expansion components disposed with said dispensing tips and said collecting tips.

11. An analytical system comprising: a plurality of dispensing tips in an array format, each said dispensing tip having a conjugate collecting tip within said array format; a support network which delineates said array format; and one or more means for moving said dispensing tips or said collecting tips independently of one another.

12. An analytical system according to claim 11, wherein said plurality of dispensing tips are dispensing tip pairs having at least one conjugate collecting tip, said dispensing tip pairs capable shifting independent of one another and independent of said collecting tips.

13. A method of transferring fluids comprising:
providing an array of transfer units, said array comprising at least a first sub-array of transfer units and at least a second sub-array of transfer units; and
shifting said first sub-array of transfer units in a vertical direction independent from a position of said second sub-array of transfer units.

14. The method of claim 13, further comprising a step of withdrawing fluid from a storage source into said first sub-array of transfer units prior to said step of shifting.

15. The method of claim 13, further comprising steps of consolidating said first sub-array and said second sub-array of transfer units in a fluid head and aligning said array of transfer units in a vertical direction prior to a step of coordinating transfer of fluid in X-axis, Y-axis, or Z-axis directions.

16. The method of claim 13, wherein said step of shifting includes steps of extending or retracting said array of transfer units simultaneously or independently of one another.

17. The method of claim 13, further comprising steps of delivering fluid through a sub-array dispensing tips in a first direction and withdrawing fluid in a second direction through a sub-array of collecting tips.

18. The method of claim 13, further comprising a step of delivering a first fluid to a first sub-array of dispensing tips and delivering a second fluid to a second sub-array of dispensing tips such that one or more fluids are capable of being dispensed independently or simultaneously from said array of transfer units.

19. The method according to claim 15, further comprising a step of coordinating said array of transfer units in said X-axis, Y-axis, and Z-axis directions prior to a step of withdrawing fluid from storage reservoirs or a step of dispensing fluid.

20. The method according to claim 19, wherein said step of withdrawing includes a first step of collectively extending and retracting said first sub-array of transfer units into an array of said storage reservoirs and a second step of collectively extending and retracting a second set of said dispensing tips into said array of said storage reservoirs.
